(19) United States
(12) Patent Application Publication
(10) Pub. No.: US 2006/0072339 A1
(43) Pub. Date: Apr. 6, 2006

(54) BACKLIGHT MODULE

(76) Inventors: Hsiao-I Li, Taoyuan (TW); Hung-Lung Cheng, Taoyuan (TW); Kenny Huang, Taoyuan (TW); Mei-Luan Hsieh, Taoyuan (TW); Chia-Cheng Weng, Taoyuan (TW); Chih-Heng Huang, Taoyuan (TW); Ho-Chiang Liu, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,824

(22) Filed: Aug. 18, 2005

(30) Foreign Application Priority Data
Oct. 1, 2004 (TW) 93129778

(51) Int. Cl. F21V 7/04

(52) U.S. Cl. 362/608; 362/612; 362/622; 362/628

(57) ABSTRACT

A backlight module is provided, comprising a light emitting diode (LED), a light guide plate and a fluorescence material. The fluorescence material is disposed in a transmission path of a first light or within the light guide plate. Then the fluorescence material is excited by the first light to generate one or more second lights. The first light and the second light are mixed or the second lights with different wavelengths are mixed to form a white light to generate a plane light source with a desired color temperature.

### CROSS-REFERENCE TO RELATED APPLICATION

This application claims the priority benefit of Taiwan application serial no. 93129778, filed on Oct. 1, 2004. All disclosure of the Taiwan application is incorporated herein by reference.

### BACKGROUND OF THE INVENTION

1. Field of the Invention

The present invention relates to a plane light source, and more particularly to a backlight module.

2. Description of the Related Art

With the progress of computer, internet and multi-media technology, image data transmission has advanced to digital transmission, rather than analog transmission. In order to fit the modern life style, visual or image apparatus has become thinner and lighter. Though having some advantages, cathode ray tube (CRT) displays are still marred by their bulky size due to the electronic cavity structures and radiation generated during display. Accordingly, combining opto-electronic technology and semiconductor technology, flat plane displays (FPDs), such as liquid crystal displays (LCDs), organic electro-luminescent displays (OLEDs), and plasma display panels (PDPs), have become the mainstream display products in the market.

According to the type of light sources, LCDs are classified into reflective LCDs, transmissive LCDs, and semi-transmissive LCDs. Wherein, the transmissive LCDs and the semi-transmissive LCDs are composed of liquid crystal plates and backlight modules. A liquid crystal plate is composed of two transparent substrates and a liquid crystal layer between them. A backlight module serves as the light source of the liquid crystal plate to achieve the LCD display function. Generally, backlight modules include direct-type and side-type backlight modules.

FIG. 1 is a cross-sectional view showing a conventional direct-type backlight module. Referring to FIG. 1, the direct-type backlight module 100 comprises a frame 110, plural cold cathode fluorescence lamps (CCFLs) 120, a diffusion plate 130 and an optical film 140. Wherein, these CCFLs are disposed in the frame 110. Lights emitted from these CCFLs are roughly mixed in the frame 110, and pass through the diffusion plate 130 and the optical film 140 to serve as the plate-light source with uniform brightness. In addition, the direct-type backlight module 100 is disposed below the liquid crystal plate 150 in order to provide lights thereto.

FIG. 2 is a cross-sectional view showing a conventional side-type backlight module. Referring to FIG. 2, the side-type backlight module 200 is composed of a light guide plate 210, a CCLP 220, a reflection mask 230, an optical film 240 and a reflection plate 260. Wherein, the light guide plate 210, usually a wedge light guide plate, comprises a light-incident surface 212, a light-diffusion surface 214 and a light-emitting surface 216. The CCLP 220 is disposed adjacent to the light-incident surface 212 of the light guide plate 210, and within the reflection mask 230. The reflection plate 260 is disposed over the light-diffusion surface 214 of the light guide plate 210.

In FIG. 2, the light emitted from the CCLP 220 either reflects on the reflection mask 230 or enters the light guide plate 210 through the light-incident surface 212. The light then is diffused by the light-diffusion surface 214, reflected on the reflection plate 260, and finally is emitted from the light-emitting surface 216 of the light guide plate 210. The light emitted from the light-emitting surface 216 of the light guide plate 210 constitutes a plane light source. The plane light source is processed by the optical film 240 and provided to the liquid crystal plate 250.

In the past, backlight modules used CCLPs as light sources. With recent improvement of opto-electronic technology, light emitting diodes have become an alternative to provide light sources because of their small sizes, low operating currents, low-power consumption, long life time and low manufacturing costs.

FIG. 3 is a cross-sectional view showing a conventional side-type backlight module with light emitting modules. Referring to FIGS. 2 and 3, the backlight module 200′ in FIG. 3 is similar to the backlight module 200 in FIG. 2. The only difference is that the backlight module 200′ uses a light emitting diode 280 as a light source. Note that the backlight module 200′ uses a white light emitting diode, or red, green and blue light emitting diodes to generate white light with a desired color temperature.

FIGS. 4A and 4B are cross-sectional views showing different white light emitting diodes. Referring to FIG. 4A, the white light emitting diode 280′ comprises a red light emitting diode R, a green light emitting diode G, and a blue light emitting diode B, which are sealed in a package encapsulant 282. Red, green and blue light emitted from these light emitting diodes R, G and B are mixed to generate white light.

Referring to FIG. 4B, the white light emitting diode 280″ comprises a blue light emitting diode B and fluorescence powders 284, which are sealed in the package encapsulant 282. In the white light emitting diode 280″, the fluorescence powders 284 are excited by a portion of the blue light emitted from the blue light emitting diode B in order to generate yellow light. The yellow light is then mixed with the blue light to generate white light.

Accordingly, the white light emitting diode 280′ in FIG. 4A must comprise at least three light emitting diodes. These light emitting diodes are usually driven separately. By controlling each current flowing into each light emitting diode, white light with a desired color temperature is obtained. As a result, the manufacturing costs of the white light emitting diode 280′ cannot be really reduced and the driving method for the backlight module is more complicated. In the white light emitting diode 280″ of FIG. 4B, the uniformity of the fluorescence powders 284 in the package encapsulant 282 directly affects the color temperature of the white light, which is difficult to control. Further, additional royalties are required in manufacturing the white light emitting diode 280.″ Therefore, the manufacturing costs of the white light emitting diode 280″ cannot be really reduced.

### SUMMARY OF THE INVENTION

Accordingly, the present invention is directed to a backlight module capable of reducing the manufacturing costs.

The present invention provides a backlight module, which comprises a light emitting diode, a light guide plate and a fluorescence material. Wherein, the light emitting diode is adapted to emit a first light. In addition, the light emitting diode comprises a light-emitting surface, and the light-emitting surface of the light emitting diode comprises a first light-diffusion surface. The light guide plate is disposed adjacent to the light emitting diode. The fluorescence material is disposed between the light emitting diode and the light guide plate. The fluorescence material is also disposed on a transmission path of the first light emitted by the light emitting diode. After the first light-diffusion surface diffuses the first light, the fluorescence material is excited by the first light and emits a second light.

According to an embodiment of the present invention, the light emitting diode can be, for example, a blue light emitting diode or a blue laser diode, and the first light emitted by the light emitting diode is blue light. In addition, the fluorescence material comprises a fluorescence material for emitting yellow light. When the fluorescence material is excited by the first light (blue light), the second light emitted is yellow light. When the blue light emitted from the light emitting diode and the yellow light emitted from the florescence material excited by the blue light are completely mixed, white light with a desired color temperature is obtained. The fluorescence material may further comprise, for example, a fluorescence material for emitting green light and a fluorescence material for emitting red light. When the fluorescence material is excited by the first light (blue light), the second lights emitted therefrom are green light and red light. When the blue light emitted from the light emitting diode, and the green light and the red light emitted from the fluorescence material excited by the blue light are completely mixed, white light with a desired color temperature is obtained.

In an embodiment of the present invention, the light emitting diode can be, for example, an invisible light emitting diode, such as an ultra-violent (UV) light emitting diode. The first light emitted from the light emitting diode is invisible light, such as UV light. In addition, the fluorescence material comprises a fluorescence material for emitting red light, a fluorescence material for emitting green light and a fluorescence material for emitting blue light. When the fluorescence material is excited by the first light (blue light), the second lights emitted therefrom comprise green light, red light and blue light. When the green light, the red light and the blue light emitted from the fluorescence material excited by the blue light are completely mixed, white light with a desired color temperature is obtained.

In an embodiment of the present invention, the fluorescence material for emitting red light, the fluorescence material for emitting green light and the fluorescence material for emitting blue light can be, for example, arranged in an array, stacked over each other or mixed over the surface of, or within, the light guide plate.

In an embodiment of the present invention, the light guide plate comprises, for example, a light-incident surface, a light-diffusion surface, and a light-emitting surface.

In an embodiment of the present invention, the fluorescence material is disposed over the light-incident surface of the light guide plate. In addition, the light guide plate comprises a second light-diffusion surface, disposed over the light-incident surface, and the fluorescence material can be disposed, for example, over the second light-diffusion surface.

In an embodiment of the present invention, the light guide plate comprises a concave over the light-incident surface, for example, and the fluorescence material can be disposed, for example, in the concave. In addition, the concave further comprises a third light-diffusion surface.

In an embodiment of the present invention, the backlight module further comprises, for example, a cavity structure or an encapsulant disposed over the light-incident surface of the light guide plate to accommodate the fluorescence material or to attach the fluorescence material over the light-incident surface of the light guide module.

In an embodiment of the present invention, the guide light plate comprises, for example, a first fluorescence coating surface, located opposite to the light-incident surface. The fluorescence material is disposed over the first fluorescence coating surface of the light guide plate.

In an embodiment of the present invention, the fluorescence material can be disposed, for example, over the light-emitting surface of the light guide plate, or in the light guide plate. In addition, the fluorescence material is uniformly distributed in the light guide plate, for example, or distributed in a partial portion of the light guide plate.

In an embodiment of the present invention, the light guide plate comprises, for example, a second fluorescence coating surface, disposed adjacent to the light-incident surface. The fluorescence material can be disposed over the second fluorescence coating surface of the light guide plate.

In an embodiment of the present invention, the backlight module further comprises a prism disposed between the light guide plate and the light emitting diode. The fluorescence material is disposed within the prime.

In an embodiment of the present invention, the backlight module further comprises, for example, a reflector. Wherein, the light emitting diode is disposed below the light guide plate, and the reflector is disposed adjacent to the light guide plate and the light emitting diode. The fluorescence material is disposed over the reflector or between the reflector and the light emitting diode. In addition, the reflector comprises a reflection curved surface or plural connected reflection planes.

In an embodiment of the present invention, the backlight module further comprises a transparent plate, which is disposed between the light emitting diode and the light guide plate. The fluorescence material is disposed in the transparent plate.

In an embodiment of the present invention, the backlight module further comprises an optical film disposed over the light exiting surface of the light guide plate. The florescence material is disposed over the surface of the optical film or in the optical film. The optical film comprises, for example, a diffusion film and/or a brightness enhancement film.

In an embodiment of the present invention, the backlight module further comprises, for example, a reflector, which is disposed below the light-diffusion surface of the light guide plate, and the fluorescence material is disposed over the reflector.

In an embodiment of the present invention, the backlight module further comprises, for example, a reflection-type light guide plate. Wherein, the light emitting diode is below the light guide plate, and the reflection-type light guide plate is disposed adjacent to the light emitting diode and the light guide plate, and the fluorescence material is disposed within the reflection-type light guide plate.

In an embodiment of the present invention, the backlight module further comprises, for example, a transparent plate and a reflection-type light guide plate. The transparent plate is disposed between the light emitting diode and the light guide plate, and the fluorescence material is disposed within the transparent plate. The reflection-type light guide plate is disposed adjacent to the transparent plate and the light guide plate. The light emitting diode is disposed below the light guide plate.

The present invention provides another backlight module, which comprises a light emitting diode, a light guide plate and a fluorescence material. Wherein, the light emitting diode is adapted to emit a first light. The light guide plate is disposed adjacent to the light emitting diode. The fluorescence material is disposed within the light guide plate, wherein the fluorescence material is excited by the first light to emit a second light.

In an embodiment of the present invention, the light emitting diode can be, for example, a blue light emitting diode or a blue laser diode, and the first light emitted by the light emitting diode is blue light. In addition, the fluorescence material comprises a fluorescence material for emitting yellow light. When the fluorescence material is excited by the first light (blue light), the second light emitted is yellow light. When the blue light emitted from the light emitting diode and the yellow light emitted from the florescence material excited by the blue light are completely mixed, white light with a desired color temperature is obtained. The fluorescence material may further comprise, for example, a fluorescence material for emitting green light and a fluorescence material for emitting red light. When the fluorescence material is excited by the first light (blue light), the second lights emitted therefrom are green light and red light. When the blue light emitted from the light emitting diode, and the green light and the red light emitted from the fluorescence material excited by the blue light are completely mixed, white light with a desired color temperature is obtained.

In an embodiment of the present invention, the light emitting diode can be, for example, an invisible light emitting diode, such as an ultra-violent (UV) light emitting diode. The first light emitted from the light emitting diode is invisible light, such as UV light. In addition, the fluorescence material comprises a fluorescence material for emitting red light, a fluorescence material for emitting green light and a fluorescence material for emitting blue light. When the fluorescence material is excited by the first light (blue light), the second light emitted therefrom comprises green light, red light and blue light. When the green light, the red light and the blue light emitted from the fluorescence material excited by the blue light are completely mixed, white light with a desired color temperature is obtained.

In an embodiment of the present invention, the fluorescence material for emitting red light, the fluorescence material for emitting green light and the fluorescence material for emitting blue light can be, for example, arranged in an array, stacked over each other or mixed over the surface of, or within, the light guide plate.

In an embodiment of the present invention, the light guide plate comprises, for example, a light-incident surface, a light-diffusion surface, and a light-emitting surface.

In an embodiment of the present invention, the fluorescence material can be disposed, for example, within the light guide plate and adjacent to the light-incident surface of the light guide plate. In addition, the light guide plate comprises, for example, a second light-diffusion surface located over the light-incident surface, and the fluorescence material can be disposed, for example, in the light guide place and adjacent to the second light-diffusion surface of the light guide plate.

In an embodiment of the present invention, the fluorescence material can be uniformly distributed within the light guide plate.

The present invention disposes the fluorescence material on the transmission path of the first light emitted from the light emitting diode, or within the light guide plate, using the first light with a shorter wavelength to excite the fluorescence material to emit the second light with a longer wavelength. The first light and the second light are uniformly mixed to generate white light with a desired color temperature. In addition, the present invention can also use the first light with a shorter wavelength to excite the fluorescence material to emit plural second lights with longer wavelengths. These second lights with different wavelengths are then mixed to generate a white light with a desired color temperature. Accordingly, the present invention uses the light emitting diode emitting a short-wavelength light and the fluorescence material integrated over the surface of, or within, the light guide plate to generate a white light with a desired color temperature. The backlight module of the present invention is thus easier to fabricate.

The above and other features of the present invention will be better understood from the following detailed description of the embodiments of the invention that is provided in conjunction with the accompanying drawings.

### BRIEF DESCRIPTION OF THE DRAWINGS

FIG. 1 is a cross-sectional view showing a conventional direct-type backlight module.

FIG. 2 is a cross-sectional view showing a conventional side-type backlight module.

FIG. 3 is a cross-sectional view showing a conventional side-type backlight module with light emitting modules.

FIGS. 4A and 4B are cross-sectional views showing different white light emitting diodes.

FIGS. 5 and 6 are a top view and a side view of a backlight module according to the first embodiment of the present invention.

FIGS. 7 and 8 are a top view and a side view of a backlight module according to the second embodiment of the present invention.

FIG. 9 is a drawing showing disposition of these red, green and fluorescence material for emitting blue lights according to the second embodiment of the present invention.

FIG. 10 is a drawing showing disposition of these red, green and fluorescence material for emitting blue lights according to the second embodiment of the present invention.

FIGS. 11A-11C are top views of backlight modules according to the third embodiment of the present invention.

FIGS. 12A and 12B are top views of backlight modules according to the fourth embodiment of the present invention.

FIGS. 13A and 13B are a top view and a side view of a backlight module according to the fifth embodiment of the present invention.

FIGS. 14A-14F are top views of backlight modules according to the sixth embodiment of the present invention.

FIGS. 15-21 are top views of backlight modules according to the seventh embodiment of the present invention.

FIGS. 22 and 23 are side views of backlight modules according to the eighth embodiment of the present invention.

FIGS. 24 and 25 are side views of backlight modules according to the ninth embodiment of the present invention.

FIG. 26 is a side view of a backlight module according to the tenth embodiment of the present invention.

FIG. 27 is a cross-sectional side view of a backlight module according to the eleventh embodiment of the present invention.

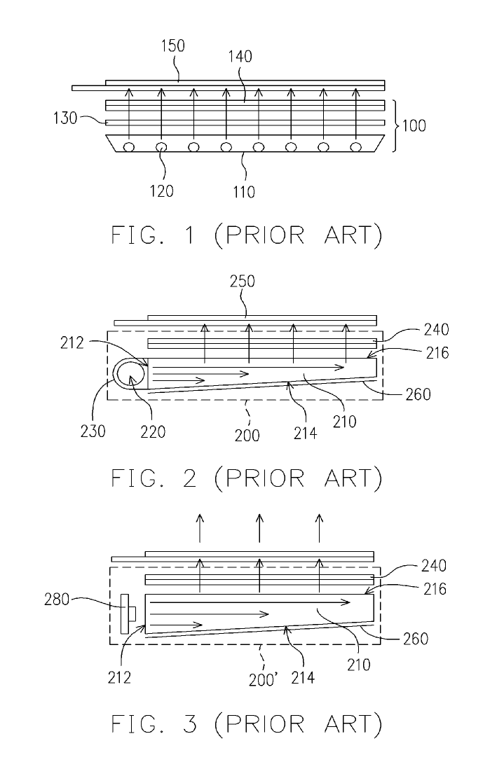

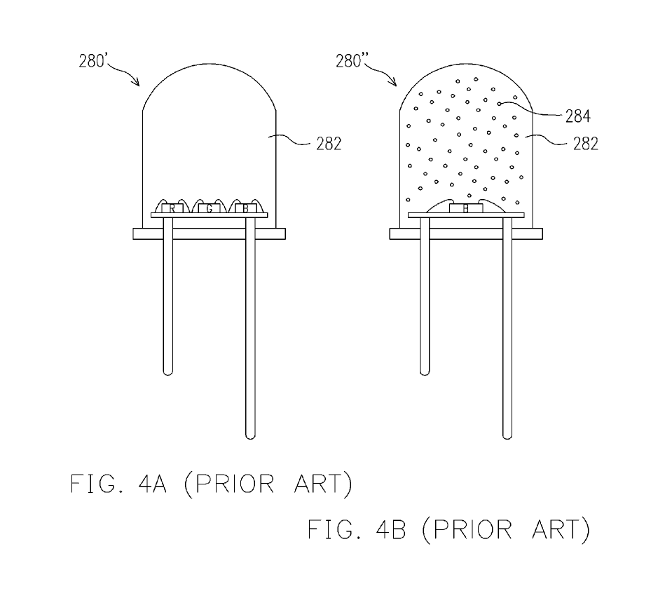

### DESCRIPTION OF SOME EMBODIMENTS

### First Embodiment

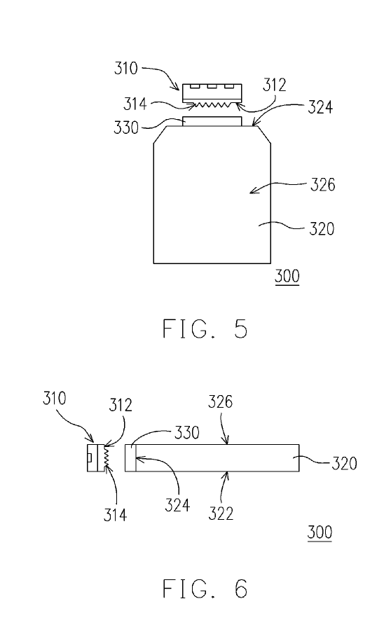

FIGS. 5 and 6 are a top view and a side view of a backlight module according to the first embodiment of the present invention. Referring to FIGS. 5 and 6, the backlight module 300 of this embodiment comprises a light emitting diode 310, a light guide plate 320 and a fluorescence material 330. Wherein, the light emitting diode 310 is adapted to emit a first light. The light emitting diode 310 comprises a first light-emitting surface 312, and a first light-diffusion surface 314 is located over the first light-emitting surface 312. The light guide plate 320 is disposed adjacent to the light emitting diode 310. The fluorescence material 330 is disposed between the light emitting diode 310 and the light guide plate 320, and on the transmission path of the first light. Wherein, after the first light-diffusion surface 314 diffuses the first light, the fluorescence material 330 is excited by the first light and emits a second light. Note that the shape of the first light-diffusion surface 314 can be, for example, a toothed type structure or other types capable of diffusing light. In other words, in this embodiment, the scattering effect of light emitted from the light emitting diode 310 can be controlled by modifying the shape of the first light-diffusion surface 314. In this embodiment, the light guide plate 320 may comprise, for example, a light-diffusion surface 322, a light-incident surface 324, and a light-emitting surface 326.

In this embodiment, the light emitting diode 310 can be, for example, a blue light emitting diode or a blue laser diode. The fluorescence material 330 can be composed of, for example, a fluorescence material for emitting yellow light. In other words, when excited by blue light emitted from the blue light emitting diode or the blue laser diode 310, the fluorescence material 330 emits yellow light. The yellow light will mix with the blue light emitted from the blue light emitting diode or the blue laser diode 310 in the light guide plate 320 in order to generate white light, which is emitted from the light-emitting surface 326 of the light guide plate 320.

In this embodiment, the fluorescence material 330 described above can be composed of, for example, a fluorescence material for emitting green light and a fluorescence material for emitting red light. When excited by blue light emitted from the blue light emitting diode or the blue laser diode 310, the fluorescence material 330 emits green light and red light. The green light and the red light mix with the blue light emitted from the blue light emitting diode or the blue laser diode 310 in the light guide plate 320 in order to generate white light, which is emitted from the light-emitting surface 326 of the light guide plate 320.

### Second Embodiment

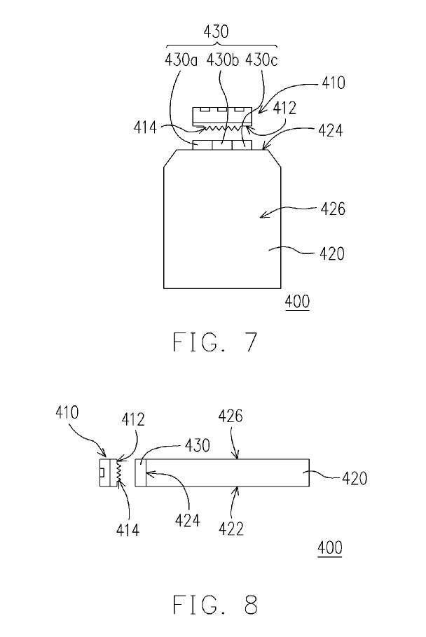

FIGS. 7 and 8 are a top view and a side view of a backlight module according to the second embodiment of the present invention. Referring to FIGS. 7 and 8, the backlight module 400 of this embodiment comprises a light emitting diode 410, a light guide plate 420 and plural fluorescence materials 430. Wherein, the light emitting diode 410 is adapted to emit a first light. The light emitting diode 410 comprises a first light-emitting surface 412, and a first light-diffusion surface 414 is located over the first light-emitting surface 412. The light guide plate 420 is disposed adjacent to the light emitting diode 410. The fluorescence materials 430 are disposed between the light emitting diode 410 and the light guide plate 420, and on the transmission path of the first light. Wherein, after the first light-diffusion surface 414 diffuses the first light, the fluorescence material 430 is excited by the first light and emits a second light. Note that the shape of the first light-diffusion surface 414 can be, for example, a toothed type structure or other types capable of diffusing light. In other words, in this embodiment, scattering effect of light emitted from the light emitting diode 410 can be controlled by modifying the shape of the first light-diffusion surface 414. In this embodiment, the light guide plate 420 may comprise, for example, a light-diffusion surface 422, a light-incident surface 424, and a light-emitting surface 426.

In this embodiment, the light emitting diode 410 can be, for example, an invisible light emitting diode 410, which preferably is an ultra-violent light emitting diode (UV LED). The fluorescence materials 430 are composed of, for example, a fluorescence material for emitting red light 430a, a fluorescence material for emitting green light 430b and a fluorescence material for emitting blue light 430c. In other words, when excited by the blue light emitted from the invisible light emitting diode 410, the fluorescence material for emitting red light 430a, the fluorescence material for emitting green light 430b and the fluorescence material for emitting blue light 430c emit red light, green light and blue light, respectively. The red, green and blue lights mix within the light guide plate 420 to generate white light, which is emitted from the light-emitting surface 426 of the light guide plate 420.

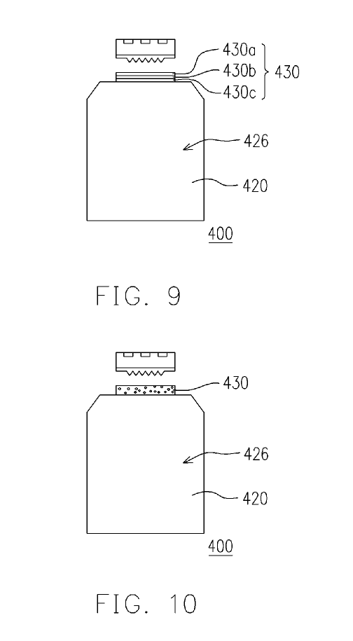

FIGS. 9 and 10 are drawings showing disposition of these fluorescence materials for emitting red, green and blue lights according to the second embodiment of the present invention. Referring to FIGS. 7, 9 and 10, the fluorescence material for emitting red light 430a, the fluorescence material for emitting green light 430b and the fluorescence material for emitting blue light 430c are arranged in an array over the surface of, or within, the light guide plate 420 as shown in FIG. 7, for example. In addition, the fluorescence material for emitting red light 430a, the fluorescence material for emitting green light 430b and the fluorescence material for emitting blue light 430c can also be stacked over each other over the surface of, or within, the light guide plate 420 as shown in FIG. 9, without limiting the order of the stack. Moreover, the fluorescence material for emitting red light 430a, the fluorescence material for emitting green light 430b and the fluorescence material for emitting blue light 430c may be mixed over the surface of, or within, the light guide plate 420 as shown in FIG. 10, for example.

The first and the second embodiments use the first light with a shorter wavelength emitted from the light emitting diode to excite the fluorescence material to generate the second light with a desired wavelength. By mixing the first light and the second light, or mixing the second light with different wavelength, white light is thus generated. The present invention, however, is not limited thereto. The following are descriptions with respect to the type of the light emitting diode, the shape of the light guide plate, and the disposition of the fluorescence material.

### Third Embodiment

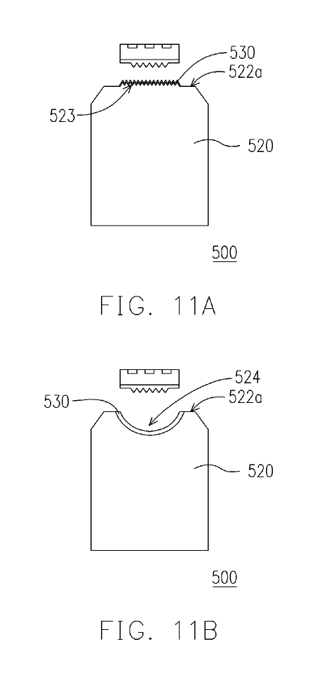

FIGS. 11A-11C are top views of backlight modules according to the third embodiment of the present invention. Referring to FIG. 11A, the light guide plate 520 of the present invention comprises, for example, a second light-diffusion surface 523 over the light-incident surface 522a. In addition, the fluorescence material 530 is coated over the second diffusion surface 523 of the light guide plate 520, for example. Due to the toothed type structure of the second light-diffusion surface 523 of the light guide plate 520 shown in FIG. 11A, or the other types of surface capable of diffusing light, the light-mixing effect of the light guide plate 520 can be improved. In addition, the second light-diffusion surface 523 of the light guide plate 520 can enhance the adhesion between the fluorescence material 530 and the light guide plate 520.

Referring to FIG. 11B, the light guide plate 520 of this embodiment may comprise a concave 524 over the light-incident surface 522a, and the fluorescence material 530 can be, for example, coated in the concave 524. In this embodiment, the concave 524 can be, for example, a semi-spherical concave or other shapes. From FIG. 11B, the concave 524 not only helps the coating of the fluorescence material 530 on the surface of the light guide plate 520, but also increases the amount of the fluorescence material 530 coated thereon. Accordingly, when a great amount of the fluorescence material 530 coated on the light guide plate 520 is required, the present embodiment is able to fulfill that purpose.

Referring to FIG. 11C, the light guide plate 520 of this embodiment may further comprise a concave 524′ over the light-incident surface 522a, and a third light-diffusion surface 525 is formed over the concave 524′. The fluorescence material 530 is coated over the third light-diffusion surface 525 in the concave 524′. Not only can the amount of the fluorescence material 530 coated on the light guide plate 520 be increased, but the adhesion between the fluorescence material 530 and the light guide plate 520 can also be enhanced.

### Fourth Embodiment

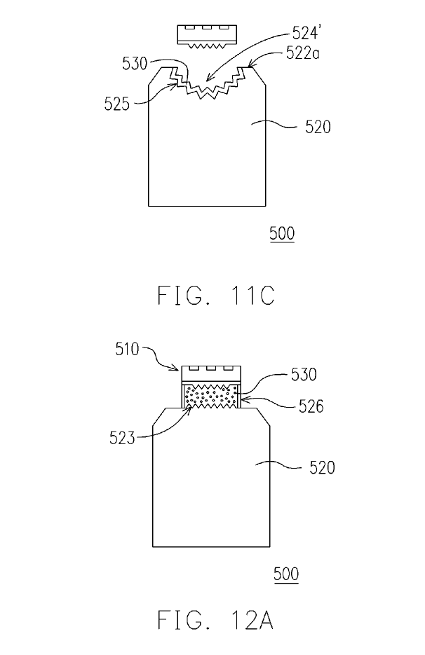

FIGS. 12A and 12B are top views of backlight modules according to the fourth embodiment of the present invention. Referring to FIG. 12A, the backlight module 500 of this embodiment, for example, further comprises a cavity structure 526. The cavity structure 526 is disposed over the surface of the light guide plate 520, for example, and between the light guide plate 520 and the light emitting diode 510. In this embodiment, the cavity structure 526 serves to accommodate a desired amount of the fluorescence material 530.

Referring to FIG. 12B, the backlight module 500 of this embodiment, for example, further comprises an encapsulant 527. The encapsulant 527 attaches the fluorescence material 530 over the second light-diffusion surface 523. In this embodiment, the encapsulant 527 is preferably a transparent material, or other materials penetrable by light.

### Fifth Embodiment

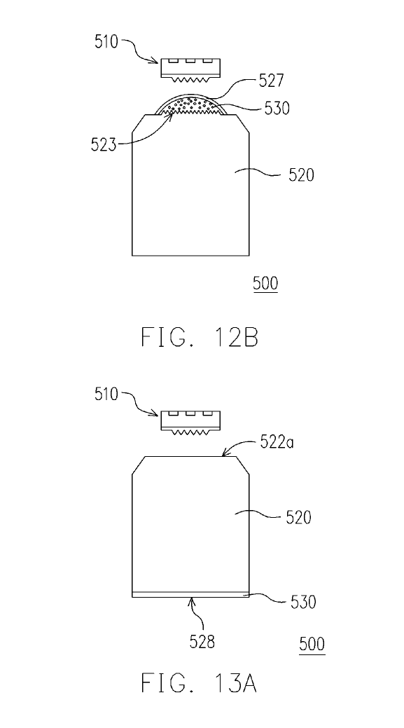

FIGS. 13A and 13B are a top view and a side view of a backlight module according to the fifth embodiment of the present invention. Referring to FIG. 13A, the backlight module 500 of this embodiment comprises, for example, a first fluorescence coating surface 528. The first fluorescence coating surface 528 is opposite to the light-incident surface 522a. In other words, the fluorescence 530 is coated over the first fluorescence coating surface 528 of the light guide plate 520. In this embodiment, when the light emitting diode 510 is a blue light emitting diode or a blue laser diode, the first light (blue light) emitted from the light emitting diode 510 enters the light guide plate 520, and then excites the fluorescence material 530 coated over the first fluorescence coating surface 528 in order to generate the second light (yellow light).

Referring to FIG. 13B, in this embodiment the fluorescence 530 can be coated over the light-emitting surface 522b of the light guide plate 520. Similarly, when the light emitting diode 510 is a blue light emitting diode or a blue laser diode, the first light (blue light) emitted from the light emitting diode 510 enters the light guide plate 520, and then excites the fluorescence material 530 coated over the light-emitting surface 522b in order to generate the second light (yellow light).

### Sixth Embodiment

Different from the third, fourth and fifth embodiments described above, in the backlight module 500 of this embodiment, the fluorescence material 530 is disposed within the light guide plate 520.

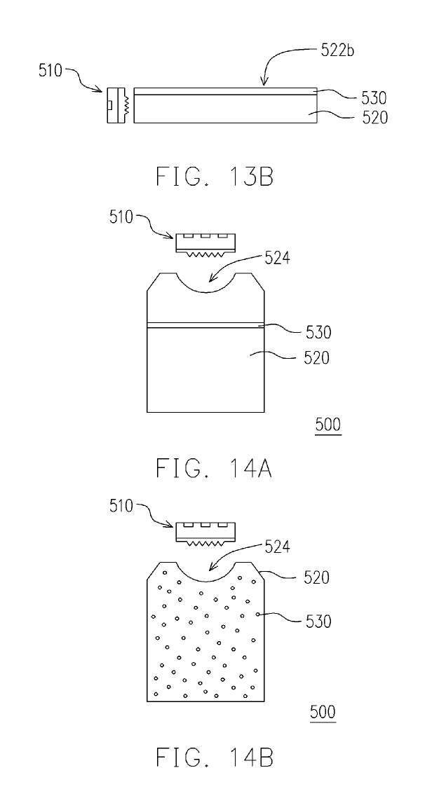

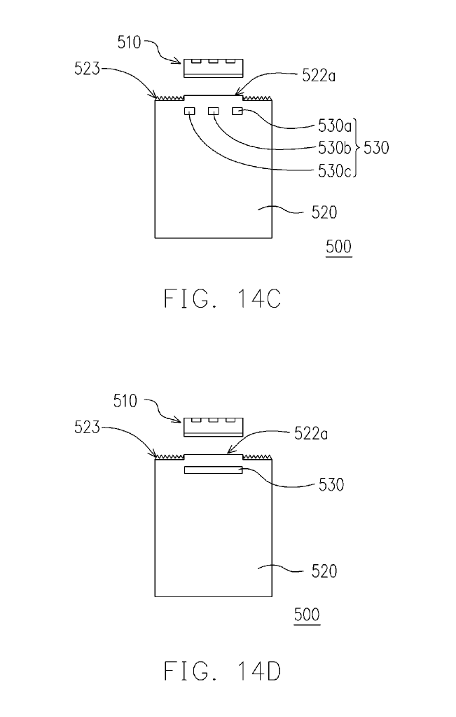

FIGS. 14A-14F are top views of backlight modules according to the sixth embodiment of the present invention. Referring to FIGS. 14A-14B, the fluorescence material 530 of this embodiment can be, for example, disposed in a partial portion of the light guide plate 520 as shown in FIG. 14A. The scope and the location of the partial portion depend on the manufacturing requirement and is not limited in the present invention. In addition, the fluorescence material 530 can also be uniformly distributed within the light guide plate 520 as shown in FIG. 14B. The density and amount of the fluorescence material 530 depend on the manufacturing requirement and is not limited in the present invention.

Referring to FIGS. 14C-14E, the fluorescence material 530 can be arranged in an array in the light guide plate 520 and adjacent to the second light-diffusion surface 523 over the light-incident surface 522a as shown in FIG. 14C, for example. Wherein, the light emitting diode 510 does not necessarily include the first light-diffusion surface. In addition, in FIG. 14D, the fluorescence material 530 can be a stripe shape, which is adjacent to the second light-diffusion surface 523 over the light-incident surface 522a. In this embodiment, the first light, such as UV light, emitted from the light emitting diode 510 can be diffused by the second light-diffusion surface 523, and the diffused first light excites the fluorescence material 530 in the light guide plate 520 to generate the second light, such as red light, green light, and blue light. The second light with different wavelengths is uniformly mixed in the light guide plate 520 to generate white light with a desired color temperature.

Please refer to FIGS. 14C, 14E and 14F. In FIG. 14C, the fluorescence material 530 can be composed of the fluorescence material for emitting red light 530a, the fluorescence material for emitting green light 530b and the fluorescence material for emitting blue light 530c arranged in an array and within the light guide plate 520, for example. In addition, the fluorescence material for emitting red light 530a, the fluorescence material for emitting green light 530b and the fluorescence material for emitting blue light 530c can also be stacked over each other within the light guide plate 520 as shown in FIGS. 14E. Moreover, the stack order of the fluorescence material is not limited. The fluorescence material for emitting red light 530a, the fluorescence material for emitting green light 530b and the fluorescence material for emitting blue light 530c may be mixed within the light guide plate 520 as shown in FIG. 14F, for example.

### Seventh Embodiment

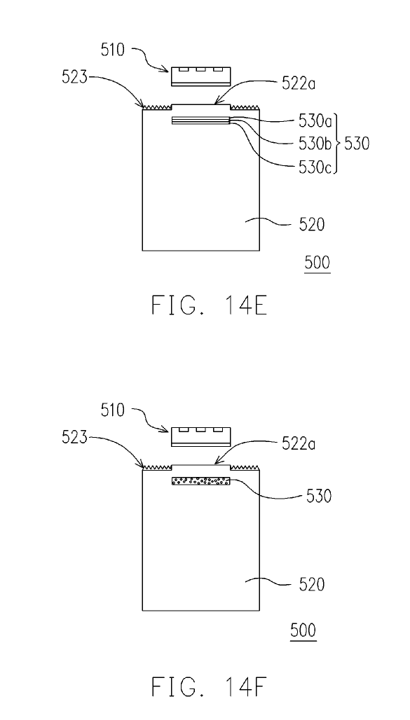

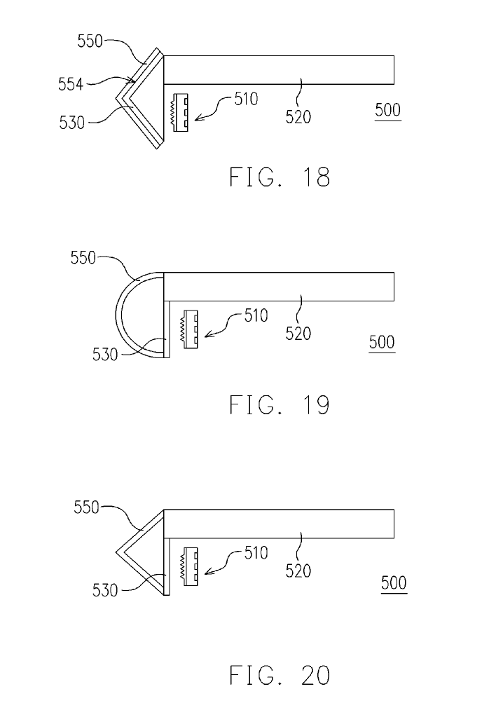

FIGS. 15-21 are side views of backlight modules according to the seventh embodiment of the present invention. Referring to FIG. 15, in the backlight module 500 of this embodiment, the light guide plate 520 comprises a second fluorescence coating surface 529, which is adjacent to the light-incident surface 522a. The fluorescence material 530 is disposed over the second fluorescence coating surface 529. In order to excite the fluorescence material 530 with the first light emitted from the light emitting diode 510, the light emitting diode 510 is disposed below the light guide plate 520.

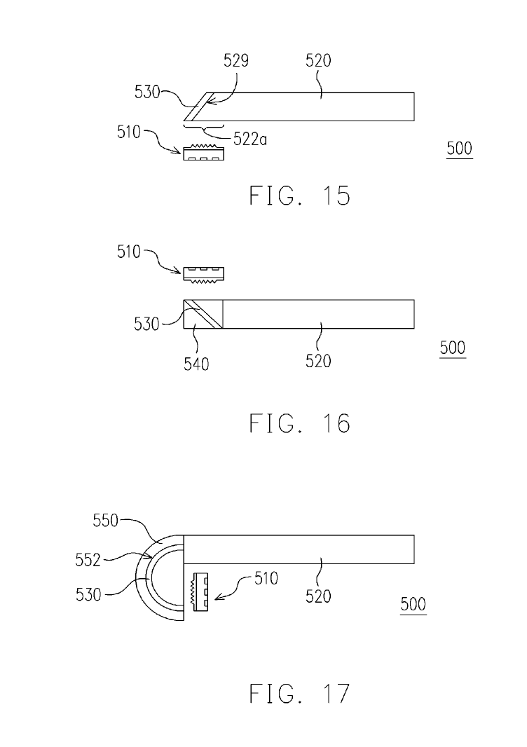

Please refer to FIGS. 16-18. The backlight module 500 of this embodiment further comprises a prism 540 in FIG. 16. The fluorescence material 530, for example, is coated in the prime 540. In addition, the prime of this embodiment can be replaced by an apparatus, such as a reflector 550 or other optical devices, which can carry the fluorescence material 530 as shown in FIGS. 17 and 18. In this embodiment, the reflector 550 comprises, for example, a reflection curved surface 552 as shown in FIG. 17, or plural reflection planes 554. FIG. 18 shows a structure with only two reflection planes. Note that the fluorescence material 530 of this embodiment is coated over the reflection curved surface 552 of the reflector 550 in FIG. 17 or the reflection planes 554 in FIG. 18.

Compared with FIGS. 17 and 18, FIGS. 19 and 20 show structures with different disposition of the fluorescence material 530. In addition to being coated over the reflection curved surface or reflection planes of the reflector 550, the fluorescence material 530 can be disposed between the light emitting diode 510 and the reflector 550. For example, the fluorescence material 530 can be first coated over a transparent substrate, and then the transparent substrate with the fluorescence material 530 is disposed between the light emitting diode 510 and the reflector 550. Of course, the present invention is not limited thereto. Any embodiments with the fluorescence material 530 disposed between the light emitting diode 510 and the reflector 550 still fall within the scope of the present invention.

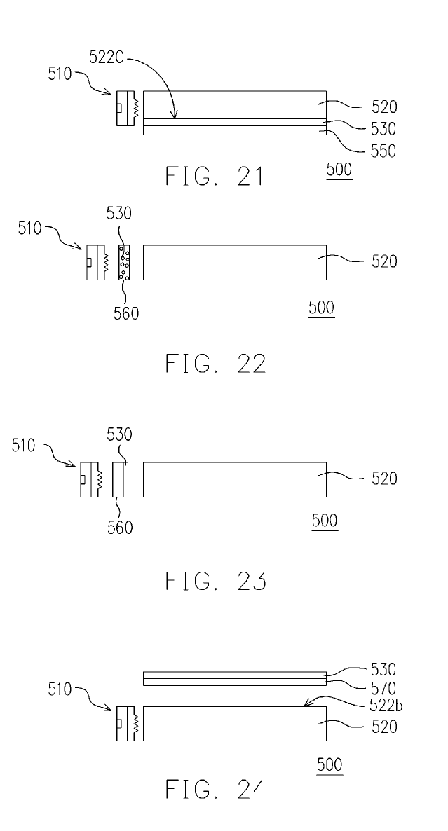

Referring to FIG. 21, the reflector 550 may also be disposed below the light-diffusion surface 522c of the light guide plate 520, for example. By disposing the fluorescence material 530 over the reflector 550, the first light emitted from the light emitting diode 510 excites the fluorescence material 530 to generate the second light. Wherein, the fluorescence material 530 can be disposed over the reflector 550, for example.

### Eighth Embodiment

FIGS. 22 and 23 are side views of backlight modules according to the eighth embodiment of the present invention. Referring to FIG. 22, the backlight module 500 of this embodiment may further comprise a transparent plate 560, and the fluorescence material 530 is disposed in the transparent plate 560. In order to excite the fluorescence material 530 with the first light emitted from the light emitting diode 510, the transparent plate 560 is disposed between the light emitting diode 510 and the light guide plate 520. In this embodiment, when the light emitting diode 510 is a blue light emitting diode or a blue laser diode, the first light (blue light) emitted from the light emitting diode 510 excites the fluorescence material 530 in the transparent plate 560 in order to generate the second light (yellow light), and then enters the light guide plate 520.

Referring to FIG. 23, the fluorescence material 530 of this embodiment can be disposed over a surface of the transparent plate 560. Similarly, when the light emitting diode 510 is a blue light emitting diode or a blue laser diode, the first light (blue light) emitted from the light emitting diode 510 excites the fluorescence material 530 in the transparent plate 560 in order to generate the second light (yellow light), and then enters the light guide plate 520.

### Ninth Embodiment

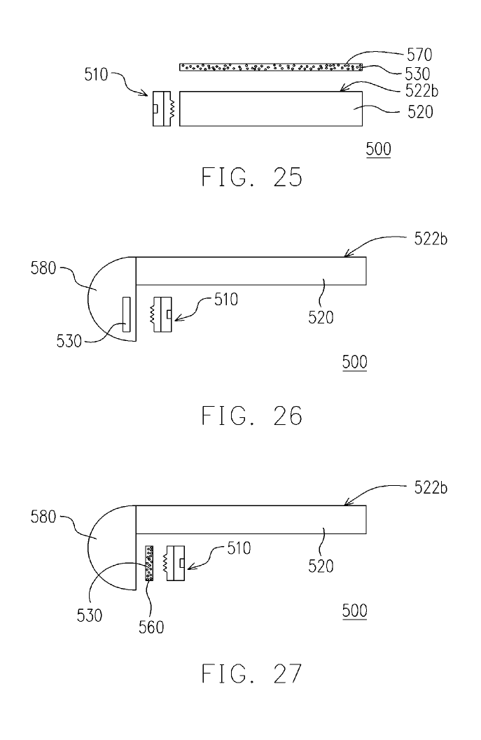

FIGS. 24 and 25 are side views of backlight modules according to the ninth embodiment of the present invention. Referring to FIG. 24, the backlight module 500 of this embodiment may further comprise an optical film 570, and the fluorescence material 530 is disposed over a surface of the optical film 570. In order to excite the fluorescence material 530 with the first light emitted from the light emitting diode 510, the optical film 570 is disposed over the light-emitting surface 522b of the light guide plate 520. In this embodiment, when the light emitting diode 510 is a blue light emitting diode or a blue laser diode, the first light (blue light) emitted from the light emitting diode 510 enters the light guide plate 520, is emitted from the light-emitting surface 522b, and then excites the fluorescence material 530 over the surface of the optical film 570 in order to generate the second light (yellow light).

Referring to FIG. 25, the fluorescence material 530 is disposed in the optical film 570. Similarly, when the light emitting diode 510 is a blue light emitting diode or a blue laser diode, the first light (blue light) emitted from the light emitting diode 510 enters the light guide plate 520, is emitted from the light-emitting surface 522b, and then excites the fluorescence material 530 over the surface of the optical film 570 in order to generate the second light (yellow light). In addition, the optical film in FIGS. 24 and 25 can be, for example, a diffusion film and/or a brightness enhancement film.

### Tenth Embodiment

FIG. 26 is a side view of a backlight module according to the tenth embodiment of the present invention. Referring to FIG. 26, the backlight module 500 of this embodiment may further comprise a reflection-type light guide plate 580, and the fluorescence material 530 is disposed in the reflection-type light guide plate 580. In order to excite the fluorescence material 530 with the first light emitted from the light emitting diode 510, the light emitting diode 510 is disposed below the light guide plate 520, and the reflection-type light guide plate 580 is disposed adjacent to the light emitting diode 510 and the light guide plate 520. In this embodiment, when the light emitting diode 510 is a blue light emitting diode or a blue laser diode, the first light (blue light) emitted from the light emitting diode 510 enters the reflection-type light guide plate 580, and then excites the fluorescence material 530 in the reflection-type guide plate 580 in order to generate the second light (yellow light). White light generated from the reflection-type light guide plate 580 and the light guide plate 520 is emitted from the light-emitting surface 522b.

### Eleventh Embodiment

FIG. 27 is a cross-sectional side view of a backlight module according to the eleventh embodiment of the present invention. Referring to FIG. 27, the backlight module 500 of this embodiment may further comprise a transparent plate 560 and a reflection-type light guide plate 580, and the fluorescence material 530 is disposed in the transparent plate 560. In order to excite the fluorescence material 530 with the first light emitted from the light emitting diode 510, the transparent plate 560 is disposed between the light emitting diode 510 and the light guide plate 520. The light emitting diode 510 is disposed below the light guide plate 520, and the reflection-type light guide plate 580 is disposed adjacent to the transparent plate 560 and the light guide plate 520. In this embodiment, when the light emitting diode 510 is a blue light emitting diode or a blue laser diode, the first light (blue light) emitted from the light emitting diode 510 excites the fluorescence material 530 in the transparent plate 560 in order to generate the second light (yellow light). White light generated from the reflection-type light guide plate 580 and the light guide plate 520 is emitted from the light-emitting surface 522b.

Accordingly, the backlight module of the present invention has at least the following advantages:

The present invention disposes the fluorescence material on the transmission path of the first light, or in the light guide plate. The first light with a shorter wavelength excites the fluorescence material to generate the second light with a longer wavelength. The first light and the second light are uniformly mixed to generate a white light.

The present invention uses the first light with a shorter wavelength to excite these second lights with plural long wavelengths. These second lights are uniformly mixed to generate a white light.

Without using red, green and blue light emitting diodes, the backlight module of the present invention can generate white light. Manufacturing costs for the backlight module are thus reduced and the driving method for the backlight module is easier.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A backlight module, comprising:
a light emitting diode, adapted to emit a first light, wherein the light emitting diode comprises a light-emitting surface, and the light-emitting surface of the light emitting diode is a first light-diffusion surface;
a light guide plate, disposed adjacent to the light emitting diode; and
a fluorescence material, disposed between the light emitting diode and the light guide plate and on a transmission path of the first light, wherein the first light-diffusion surface diffuses the first light, and the fluorescence material is excited by the first light and emits a second light.

2. The backlight module of claim 1, wherein the light emitting diode comprises a blue light emitting diode, and the first light is blue light.

3. The backlight module of claim 2, wherein the fluorescence material comprises a fluorescence material for emitting yellow light, and the second light is yellow light.

4. The backlight module of claim 2, wherein the fluorescence material comprises a fluorescence material for emitting green light and a fluorescence material for emitting red light, and the second light comprises green light and red light.

5. The backlight module of claim 2, wherein the blue light emitting diode comprises a blue laser diode.

6. The backlight module of claim 1, wherein the light emitting diode comprises an invisible light emitting diode, and the first light is invisible light.

7. The backlight module of claim 6, wherein the fluorescence material comprises a fluorescence material for emitting red light, a fluorescence material for emitting blue light and a fluorescence material for emitting green light, and the second light comprises red light, blue light and green light.

8. The backlight module of claim 6, wherein the fluorescence material for emitting red light, the fluorescence material for emitting blue light and the fluorescence material for emitting green light are arranged in an array, stacked over to each other or mixed each other.

9. The backlight module of claim 6, wherein the light emitting diode comprises an ultra-violent (UV) light emitting diode.

10. The backlight module of claim 1, wherein the light guide plate comprises a light-incident surface, a light-diffusion surface and a light-emitting surface.

11. The backlight module of claim 10, wherein the fluorescence material is disposed over the light-incident surface of the light guide plate.

12. The backlight module of claim 11, wherein the light guide plate comprises a second light-diffusion surface located over the light-incident surface, and the fluorescence material is disposed over the second light-diffusion surface.

13. The backlight module of claim 11, wherein the light guide plate comprises a concave, located over the light-incident surface, and the fluorescence material is disposed in the concave.

14. The backlight module of claim 13, wherein the concave comprises a third light-diffusion surface.

15. The backlight module of claim 11, further comprising a cavity structure located over the light-incident surface of the light guide plate to accommodate the fluorescence material.

16. The backlight module of claim 11, further comprising an encapsulant disposed over the light-incident surface of the light guide plate to cover and attach the fluorescence material over the light-incident surface of the light guide plate.

17. The backlight module of claim 10, wherein the guide light plate further comprises a first fluorescence coating surface, located opposite to the light-incident surface, and the fluorescence material is disposed over the first fluorescence coating surface of the light guide plate.

18. The backlight module of claim 10, wherein the fluorescence material is disposed over the light-emitting surface of the light guide plate.

19. The backlight module of claim 1, wherein the fluorescence material is disposed in the light guide plate.

20. The backlight module of claim 1, wherein the fluorescence material is uniformly distributed in the light guide plate, or distributed in a partial portion of the light guide plate.

21. The backlight module of claim 10, wherein the light guide plate further comprises a second fluorescence coating surface, adjacent to the light-incident surface, and the fluorescence material is disposed over the second fluorescence coating surface of the light guide plate.

22. The backlight module of claim 1, further comprising a prism disposed between the light guide plate and the light emitting diode, and the fluorescence material being disposed within the prism.

23. The backlight module of claim 1, further comprising a reflector, wherein the light emitting diode is disposed below the light guide plate, the reflector is disposed adjacent to the light guide plate and the light emitting diode, and the fluorescence material is disposed over the reflector or between the reflector and the light emitting diode.

24. The backlight module of claim 23, wherein the reflector comprises a reflection curved surface or plural connected reflection planes.

25. The backlight module of claim 1, further comprising a transparent plate disposed between the light emitting diode and the light guide plate, the fluorescence material being disposed in the transparent plate.

26. The backlight module of claim 10, further comprising at least one optical film disposed over the light-emitting surface of the light guide plate, the fluorescence material being disposed within the optical film or over a surface of the optical film.

27. The backlight module of claim 26, wherein the optical film comprises a diffusion film and/or a brightness enhancement film.

28. The backlight module of claim 10, further comprising a reflector disposed below the light-diffusion surface of the light guide plate, the fluorescence material being disposed over the reflector.

29. The backlight module of claim 10, further comprising a reflection-type light guide plate, wherein the light emitting diode is below the light guide plate, the reflection-type light guide plate is disposed adjacent to the light emitting diode and the light guide plate, and the fluorescence material is disposed within the reflection-type light guide plate.

30. The backlight module of claim 1, further comprising:
a transparent plate disposed between the light emitting diode and the light guide plate, the fluorescence material being disposed within the transparent plate; and
a reflection-type light guide plate, wherein the light emitting diode is below the light guide plate, and the reflection-type light guide plate is disposed between the light emitting diode and the light guide plate or between the transparent plate and the light guide plate.

31. A backlight module, comprising:
a light emitting diode adapted to emit a first light;
a light guide plate disposed adjacent to the light emitting diode; and
a fluorescence material disposed within the light guide plate, wherein the fluorescence material is excited by the first light to emit a second light.

32. The backlight module of claim 31, wherein the light emitting diode comprises a blue light emitting diode, and the first light is blue light.

33. The backlight module of claim 32, wherein the fluorescence material comprises a fluorescence material for emitting yellow light, and the second light is yellow light.

34. The backlight module of claim 32, wherein the fluorescence material comprises a fluorescence material for emitting green light and a fluorescence material for emitting red light, and the second light comprises green light and red light.

35. The backlight module of claim 32, wherein the blue light emitting diode comprises a blue laser diode.

36. The backlight module of claim 31, wherein the light emitting diode comprises an invisible light emitting diode, and the first light is invisible light.

37. The backlight module of claim 36, wherein the fluorescence material comprises a fluorescence material for emitting red light, a fluorescence material for emitting blue light and a fluorescence material for emitting green light, and the second light comprises red light, blue light and green light.

38. The backlight module of claim 36, wherein the fluorescence material for emitting red light, the fluorescence material for emitting blue light and the fluorescence material for emitting green light are arranged in an array, stacked over to each other or mixed each other.

39. The backlight module of claim 36, wherein the light emitting diode comprises an ultra-violent (UV) light emitting diode.

40. The backlight module of claim 31, wherein the light guide plate comprises a light-incident surface, a light-diffusion surface and a light-emitting surface.

41. The backlight module of claim 40, wherein the fluorescence material is disposed adjacent to the light-incident surface and within the light guide plate.

42. The backlight module of claim 41, wherein the light guide plate comprises a second light-diffusion surface located over the light-incident surface, and the fluorescence material is disposed adjacent to the light-diffusion surface and within the light guide plate.

43. The backlight module of claim 31, wherein the fluorescence material is uniformly distributed in the light guide plate.
